(19) United States
(12) Patent Application Publication
(10) Pub. No.: US 2005/0142265 A1
(43) Pub. Date: Jun. 30, 2005

(54) Preservation of sugar cane and other plant materials

(76) Inventor: Druce Barry Batstone, Queensland (AU)

Correspondence Address: STEPTOE & JOHNSON LLP, 1330 CONNECTICUT AVENUE, N.W., WASHINGTON, DC, 20036, US

(21) Appl. No.: 10/511,550

(22) PCT Filed: Apr. 17, 2003
(86) PCT No.: PCT/AU03/00466

(30) Foreign Application Priority Data
Apr. 18, 2002 (AU) PS 1808

(51) Int. Cl. A23P 1/00

(52) U.S. Cl. 426/489

(57) ABSTRACT

A process for the preservation of plant materials comprising the steps of crushing the plant materials to separate a juice portion and a pulp portion, thermally dewatering said pulp portion to form a dewatered pulp, concentrating said juice portion to form a syrup, and combining said dewatered pulp and said syrup to form a preserved plant material.

### FIELD OF THE INVENTION

The present invention relates to a process for preserving sugar cane and other plant materials.

### BACKGROUND ART

Sugar cane is normally harvested in the winter months when the sucrose content is highest. As a result the crushing period may be as short as 20 weeks. A typical operating period for a sugar cane factory is 3000 hours per annum. The equipment in sugar cane factories must therefore be sized to a capacity to enable the processing for all the year to be conducted in this short season. The consequences are high capital investment and plant that lies idle for more than 60% of the year.

Various attempts have been made to extend the production period for sugar by storage of an intermediate syrup product. In the more tropical conditions where sugar cane is grown, sucrose losses during storage of syrup have prevented the adoption of syrup processing. A further drawback with syrup storage in the sugar cane industry is the need to store bagasse. Bagasse is used as a fuel source for the generation of heat in the processing of the syrup. If bagasse is not used it is necessary to employ an alternative fuel that would render the syrup processing less economic.

The concept of preserving sugar cane received attention in the middle of the 19th century. For example the book “Sugar Growing and Refining” by C. G. W. Lock, G. W. Wigner and R. H. Harland, published in London and New York by E. and F. N. Spon in 1882 refers to slicing and drying sugar cane in the Caribbean. The intention was to preserve the cane for transport and processing to sugar and paper in France.

Desiccation of sugar beet is referenced in a recent book “Sugar Technology” P. W. van de Pol et. al (eds) published by Bartens, Berlin 1998. The technical feasibility of thermal drying and subsequent processing has been demonstrated, but the costs are prohibitive. This is to be expected, as significant quantities of fuel are needed to supply heat to remove the water in beet or sugar cane. Solar drying of beet is not practical in the late autumn and winter in the temperate climates in areas where beet is grown. Sugar cane may be dried by solar heat on a small scale. However experimental work by the inventor has shown that solar drying is also not practical if large quantities of sugar cane are to be preserved.

The inventor has found that sugar cane may be subjected to a combination of mechanical and thermal dewatering steps to produce a preserved product that may be readily stored for later processing. Whilst the process of the present invention has been developed with specific application to the preservation of sugar cane, the inventor has observed that the process is also applicable to the preservation of other plant materials. We have found that the process may also advantageously be employed in the preservation of other fibrous plant materials including for example but not limited to, sweet sorghum, and lucerne. Plant materials that contain an appreciable proportion of fibre are amenable to removal of water and solutes in the form of juice by mechanical means. For convenience, the process of the present invention will now be described with reference to the use of the process for preserving sugar cane. It will be understood that the process will be readily applicable and adaptable to the preservation of other plant materials.

### SUMMARY OF THE INVENTION

In one broad form, the present invention provides a process for the preservation of plant materials comprising the steps of crushing the plant materials to separate a juice portion and a pulp portion, thermally dewatering said pulp portion to form a dewatered pulp, concentrating said juice portion to form a syrup, and combining said dewatered pulp and said syrup to form a preserved plant material.

Plant materials suited for preservation by the process of the present invention include a wide variety of harvested plant products. It is preferred that the plant material include a fibrous component such that the pulp produced by crushing is more readily able to be handled by equipment used in the process of the invention. It is particularly preferred that the plant material has a relatively high sugar content. We have found that the process of the present invention is particularly advantageous for use on plant materials with high sugar contents as the syrup produced is less likely to permit or promote the growth of microorganisms.

In a preferred aspect this invention provides a process for the preservation of sugar cane by a combination of mechanical and thermal dehydration steps to produce a dried fibrous material combined with a concentrated syrup. The process of the present invention may be conducted during the normal crushing season and the subsequent reprocessing and refining of the preserved cane to produce sugar and by-products may be conducted throughout the year, thereby extending the effective processing season and reducing the capacity required of plants for sugar refining.

Prior to crushing the sugar cane may be cleaned to facilitate the further processing of the preserved sugar cane. Other pre-treatments may also be employed to improve the properties of the preserved sugar cane or of the processed cane.

The sugar cane may be crushed by any convenient means. The mechanical methods of separation such as roll, screw and other forms of presses consume less energy compared to thermal removal of the equivalent proportion of water. Sugar cane is preferably crushed in a roll crusher where the sugar cane is passed between one or more nips of opposed counter-rotating rolls. Multiple rolls with multiple nips may be employed to maximise the mechanical removal of juice. Dry milling or crushing, which is mechanical pressing without the addition of water is capable of 80% juice extraction.

After crushing, the moisture in the bagasse may be reduced to about 48%. Generally by expending more mechanical energy to increase juice extraction at this step in the process reduces the energy required for thermal dewatering of the pulp. Overall, the energy efficiency of the process may be improved by optimising the amount of juice extracted from the sugar cane during the crushing step. Reduced residence times during thermal processing such as in thermal dryers generally results in less thermal degradation of the residual sugar retained in the pulp. However, the present invention contemplates a range of juice extraction rates in the mechanical extraction stage and in some processes there may be a minimum of adverse effects of thermal processing of the pulp.

The juice portion will typically contain water and solutes, generally in the same proportion as in the plant material, and may also contain a small quantity of insoluble solids, such as fibre.

The pulp portion will typically contain the fibre of the plant material although a small quantity of fibre may be extracted with the juice portion. The pulp portion will typically also contain residual water and solutes. Preferably the pulp portion has a moisture content of less than 55% by weight. When processing sugar cane in accordance with the present invention preferably the moisture content is in the range of from 46% to 52% by weight. We have found optimum moisture content in the pulp portion of crushed sugar cane to be about 48% by weight.

The pulp portion is thermally dewatered. Thermal dewatering may be performed by any convenient means whereby the pulp portion is heated to drive off water. Without wishing to be bound by theory we believe that the thermal dewatering removes bound and unbound water from the pulp portion.

Hot gasses such as those generated by combustion of gas or oil or derived from flue gas from steam generators may be used to dry the pulp portion in a variety of dryers. These dryers may take the form of rotating drums, flash type dryers whereby the material to be dried is conveyed by the drying gasses, multiple-tray, moving bed and fluidized bed dryers. Another form of drying that may be employed is solar drying.

We have found that the use of superheated steam is particularly advantageous in the dewatering of the pulp portion. Steam drying offers environmental and thermal efficiency benefits compared to drying by hot gas. In sugar processing the steam produced by evaporation of the water from the pulp portion can be used for heating in subsequent processes such as the evaporation of juice to syrup. Steam may be heated by a heat exchanger using the condensation of steam from a suitable source at a higher pressure of using hot gas from another source.

A dryer employing superheated steam or hot gasses require the containment of the superheated steam of hot gasses. In particular dryers employing superheated steam will typically operate at elevated pressures. Typically, the operating pressure of superheated steam may be 1.5 bar, higher than atmospheric pressure. Material entering and leaving the dryer, whether of the superheated steam type or hot gas type must therefore pass through some sort of gas containment device. Typically containment devices are of a type similar to a rotary valves. A rotor of generally cylindrical form has a number of chambers formed by radial extensions that have an outer surface in close contact with the inner bore of the valve housing. Material falls into the chamber and is carried around to the lower discharge point by rotation of the rotor. The presence of gasses such as steam in the pressurized chamber has been found to cause difficulties as the empty chamber carries steam to the entry point. The steam condenses and has been found to cause pulp material to stick to the outer surface of the rotor extensions that are meant to form a seal. In hot gas dryers the egress of hot gas may also be disadvantageous.

Another pressure or gas containment device is a screw feeder. This device is suitable for vegetable fibres and pulp materials used in papermaking but has not been found suitable for the clumps of fibre that are typical of pulps produced by mechanical crushing of fibrous crops like sugar cane.

We have now found a dryer configuration that is particularly suited to the dewatering of pulp in accordance with the process of the present invention. Such a dryer for dewatering pulp comprising a drying chamber, a feed assembly and a discharge assembly wherein the respective assemblies each comprise a housing having a bore with radial inlet, and an outlet, a piston disposed within said bore for reciprocation therein, and a device to reciprocate said piston wherein the radial inlet is open for charging the bore with pulp when said piston is in a first position and wherein the radial inlet is closed by said piston as the piston is driven by said device towards the outlet whereby pulp disposed within the bore is urged out of the outlet.

The dryer incorporates feed and discharge assemblies that facilitate the transport of the pulp both into and out of the dryer. The feed assembly and discharge assembly utilise the low permeability of compressed pulp to form a seal against discharge of steam from the pressurised drying chamber. The respective assemblies may be the same or different. Whilst identical assemblies may be used for both the feed and discharge, the characteristics of the pulp before and after dewatering may render it preferable for the feed and discharge assemblies to be designed to account for the different characteristics of the pulp whilst retaining the basic elements being a housing having a chamber with radial inlet, and an outlet, a piston disposed within said bore for reciprocation therein, and a device to reciprocate said piston.

Each assembly comprises a housing. The housing may be any convenient shape of sufficient dimensions to accommodate the bore and retain the configuration of the bore in use. The bore may have a circular, square, rectangular or any suitable form in cross-section. The piston will have the same form in cross-section with sufficient clearance to allow free movement in the bore.

The piston is disposed within the bore for reciprocation therein. The piston and the bore may have a cylindrical, rectangular or any other convenient shape. It is preferred that the piston be closely, but freely received in the bore. The piston is preferable sealed against the bore to prevent the egress of gas for a pressurised drying chamber. The piston face is preferably cut at an angle to the cross-section of the chamber.

The radial inlet allows the bore to be filled with pulp from a hopper or the like. The radial inlet is disposed on the bore adjacent the position of the head of the piston in its first position. In the first position the piston does not close the inlet and pulp may fill the bore. The piston head and chamber inlet may be shaped to reduce the impact loading as the piston head closes the inlet and urges the pulp towards the outlet. The piston head is preferably of sufficient length that the inlet is kept closed by the piston head during the reciprocating stroke of the piston until it returns to the first position.

The feed assembly preferably has an inlet of sufficient length when filled with pulp to effect sealing against the pressure in the drying chamber. Alternative sealing means may be employed to optimise the efficiency of the drying chamber.

Dewatering the pulp may preferably be conducted using superheated steam. In order to effect efficient heat transfer from the superheated steam to the pulp, a bed of pulp may be fluidised whereby contact between the pulp and the superheated steam drying medium is achieved by upward flow of the steam through a bed of the pulp. The steam flow causes the material in the bed to be fluidised. Fluidisation is desirable as the movement of solid particles causes enhanced mixing of the drying steam and the pulp. However, we have found that continuous fluidisation may result in overheating and unnecessarily high consumption of energy.

A suitable dryer for dewatering pulp may include a drying chamber comprising a perforated plate for supporting a bed of pulp, the perforated plate disposed above a plenum containing superheated steam wherein superheated steam is intermittently passed through the perforated plate whereby the bed of pulp is intermittently fluidised. Alternatively the steam may be forced through the bed of crushed plant material from above and collected below a perforated plate.

The intermittent fluidisation of the bed of pulp may alternatively be referred to a pulse fluidisation and produces a differential flow of drying steam to portions of the bed in pulses.

The superheated steam may be intermittently passed through the perforated plate so as to cause the bed of pulp to be momentarily fluidised. Pulses of superheated steam may be passed through the bed of pulp by a rotating baffle plate with openings generally of the same area as the area of the bed to be pulsed. The openings will normally be fixed and the speed of rotation changed to optimise the flow of superheated steam and still retains the benefits of fluidisation. A second baffle plate may be placed between the rotating baffle plate and the perforated plate to provide the differential flow to the wetter and drier portions of the bed. The second differential flow baffle plate would normally be fixed and have openings cut in the plate. If further control of flow of the drying steam either through change of the pulse affected area or change of the flow of drying steam to wetter and drier portions of the bed was needed, the openings could be made adjustable by various means including sliding plate sections that covered a variable part of the openings of the second baffle plate.

Pulses may also be caused by oscillating sections of a baffle plate. The sections are preferentially in a sector form. Each sector may be comprised of two sector pieces that may be adjusted to give a bigger or smaller gap between adjacent sector pairs thereby providing the means to achieve differential flow to wetter and drier portions of the bed and to vary the area of the bed to be momentarily pulsed. Varying the speed of oscillation provides a means for optimising the flow of drying steam while retaining the benefits of fluidisation. A further level of control of differential flow may be achieved by arranging multiples of sector pairs to be actuated by separate oscillating mechanisms at independently variable speeds.

We have found that the use of pulsed fluidisation of the bed of pulp allows the process of the present invention to be optimised to maximise drying effect at reduced steam flow rate. The flow of superheated steam to bring about fluidisation will be higher where the pulp is wet compared to where it is dry. Furthermore, the flow required for complete or continuous fluidisation may be higher than the optimum flow for drying. The optimum flow of drying steam for heat sensitive materials will be close to but higher than the flow at which the steam becomes saturated when it is in contact with the drying solids. One of the advantages of pulse fluidisation over full-bed, continuous fluidisation relates to the lower volume flow of the fluidising material. Velocity above the bed is lower in pulse fluidisation. Carry-over of fine particles is correspondingly less and so too is the need to have vertically extended disengaging space.

For bagasse-like solids, the rate of drying is controlled by the diffusion rate of liquid within the cellular structure. Little increase in drying rate is obtained by holding the particles in a constant stream of hot gas.

In the present invention, the benefits of pulse fluidisation with superheated steam as the drying medium have been realised for the first time. Heat transfer rates from steam to a cooler solid can be very high provided condensation on the surface is limited. In a continuously fluidised bed, the solid surface will either be under or over saturated by water, as steam flow rates must lie within a narrow fluidisation range. In pulse fluidisation, the period of most intense contact between superheated steam and the solid can be adjusted to limit condensation on the surface. In the “rest” period between pulses, the water content in the particles will tend to equilibrate.

The pulp in the bed moves from the inlet to the discharge as it is dewatered. Pulp having large fibre pieces that tend to clump by mechanical entanglement such as pulps derived from crushing of sugar cane may not be reliably transported by fluidisation even with very high flows of the fluidizing medium and a highly expanded bed. We have found that the flow of dewatered pulp to the outlet may be greatly facilitated by the used of mechanical rake-like assemblies in combination with the used of a fluidised bed of pulp.

The dryer for dewatering pulp may comprise a drying chamber having a fluidised bed of pulp, said drying chamber comprising an arm extending into said bed of pulp and moving from an inlet into said drying chamber to a discharge from said drying chamber.

Preferably, such a dryer includes a multiplicity of arms disposed across the bed at one or more levels. The arms rotate or move in a direction that takes wet pulp from the inlet to the discharge. The lower arms close to a bed support screen will move more slowly than the arms higher up in the bed. During fluidisation, the drier pulp will migrate to the upper levels due to a lower density. Differential, faster movement of the dryer layers reduces the residence time during which the drier particles are subjected to higher temperature. The arms may be equipped with rake or plough-like protrusions to cause more effective transport and to assist mixing.

The dewatered pulp preferably has reduced moisture content in the range from 10% to 35% by weight. More preferably the moisture content of the dewatered pulp is in the range of 12% to 15%. The dewatered pulp material should have uniform moisture content, and the residual sugar content of sugar cane should not be adversely affected by colour derived from overheating.

The juice portion derived from the mechanical separation of the pulp and juice typically contains 15% to 23% of soluble components such as sucrose, glucose, fructose, other organic matter and soluble salts. Apart from a small amount of fibre and soil solids, the remainder is water. Water may be removed from juice by evaporation to produce a syrup. The evaporation may be carried out in stages with the first stage supplied by steam and subsequent stages heated by steam or hot gasses produced by the preceding stage. Increasing the number of stages reduces the amount of steam required for production of syrup. In the present invention, the pulp dryer supplies steam and the starting and finishing moisture content of the pulp portion may determine the quantity. For the preferred starting moisture content in the range 46% to 52% and the preferred ending moisture content range of 12% to 15%, the steam supplied by the dryer is sufficient to produce a syrup with about 70% solids in six stages.

The solids content of syrup derived from the juice of sugar cane is preferably 70% to 75%. Evaporating to higher solids content may cause spontaneous nucleation and crystallization in the final stage of evaporation. Juice from plant materials that do not contain as high a sucrose content as cane sugar may be concentrated to higher solids content.

The syrup and the dewatered pulp are combined to form the preserved sugar cane. The syrup and the dewatered pulp are combined or mixed to reconstitute the sugar cane in a dehydrated form. It is preferred that the syrup is hot, at a temperature in the range of from 65° C. to 70° C. or at the boiling temperature in the final stage for combining with the dewatered pulp. Syrup at an elevated temperature may stably retain a higher concentration of soluble solids in solution. Syrup derived from sugar cane may stably contain a concentration of soluble solids of 75% at 70° C. It is also preferred that the dewatered pulp is at a temperature not less than 90° C., thereby increasing the evaporation of water from the syrup after the syrup and dewatered pulp have been mixed. Mixing of syrup and dewatered pulp preferably takes place at the discharge point in the pulp dryer prior to the discharge device. The temperature of syrup will be increased slightly due to contact with superheated steam. The compressed material discharging from the chamber may be retained in compressed form. Further water evaporation will be from the syrup near the surface where the syrup is most vulnerable to dilution by water and infection by microorganisms.

Without wishing to be bound by theory it is believed that mixing of the syrup and the dewatered pulp has an additional dehydrating effect upon the syrup. It is believed that during thermal dewatering of the pulp, in particular during a steam drying process, water that is normally bound to fibre of the dewatered pulp is extracted. On combining the dewatered pulp with syrup, water from the syrup is rebound by the fibre having a further concentrating effect on the syrup leaving a higher concentration of soluble solids in the syrup film.

The combining of syrup and dewatered pulp has other surprising benefits. It is known that sugar cane syrup that is saturated with sucrose at the boiling temperature of the last stage of evaporation will spontaneously nucleate and form a hard solid mass as it cools. Generally, syrup to be stored or transported without risk of nucleation and hardening requires a concentration of soluble solids of less than 70%. However syrup at this concentration is known to be susceptible to yeast-infection in bulk storage. We have found that by combining the syrup with the dewatered pulp the risk of nucleation and hardening is substantially reduced. Syrup mixed with dewatered pulp while hot (typically 110° C. in the dryer and just below 100° C. after discharge) allows a higher concentration of 75% solids in the syrup to be used. This, combined with the further dehydration of the dewatered pulp due to preferential rebinding of water, increases the solids content of the syrup film absorbed on fibre to as high as 85% solids. Growth of micro-organisms at such concentrations is extremely unlikely and is usually only likely to occur when associated with dilution by water absorbed as vapour or from accidental wetting.

The preserved sugar cane may be formed into shipping container sized blocks of mixed syrup and dried bagasse under pressure thereby reducing the potential for rehydration of the preserved sugar cane. Only the surfaces of these blocks are exposed to accidental wetting. Further protection may be obtained by wrapping the blocks in plastic film. The transport and storage of blocks under cover and by using a close spacing of blocks in storage should minimise the potential for contamination by water liquid or vapour.

Advantageously the preserved material contains almost all the fibre and solutes in the original plant material. The unbound water component of the original material may be reduced by about 94%.

The preserved sugar cane may be subsequently processed in much the same manner as fresh sugar cane. The processing of the preserved cane may require two and possibly three additional items of equipment not found in an existing sugar cane factory. The first is a means of recovering the preserved material from storage in a suitably broken down form. Wheeled loaders could recover large blocks for loading into conventional bale breaking equipment. Alternatively and preferably, the stored material could be “mined” from floor level by a variation of the continuous longwall coal miner.

The second item of additional equipment is a means of mixing the dried, preserved material with the countercurrent flow of juice from the extraction equipment. This is to supply a reconstituted material to a conventional juice extraction system. This may be a milling tandem or a diffuser system. Water may be added before the last stage of extraction as normal for countercurrent washing. The quantity of water used when expressed as a percentage of dry fibre may be slightly higher than required for processing fresh sugar cane. As there is negligible moisture in preserved cane compared fresh cane which is more than two thirds water by mass, juice may be recirculated at intermediate stages of extraction (either in a milling tandem or a diffuser). The countercurrent flow of juice may reach the dried preserved material in a mixer before the first stage of extraction from the preserved sugar cane.

Juice extracted from the preserved sugar cane will have a higher concentration of solids compared to juice extracted from fresh cane. A third additional item of equipment may be required if the normal process of clarification by sedimentation is not successful with the higher concentration of solids. Flotation clarification may be required. This is a process commonly used for syrup clarification as an adjunct to raw sugar production and in refineries.

The present invention provides a process, and apparatus for use in the process, whereby plant materials may be preserved. The preservation of sugar cane advantageously permits an existing sugar cane factory to increase the quantity of sugar cane able to be processed in a year by a factory. Prior to this invention and as a result of the need to process unpreserved sugar cane in season, every section of the factory would have to be expanded to process all the sugar cane to crystal sugar in the normal season. The present invention provides for a much less costly expansion. Whilst certain modification may need to be made to an existing facility the cost of such modification is far less than the expansion required to achieve the annual processing capability provided by the present invention. Also, the preserved cane may also fill in the gaps in normal crushing caused by an inability to obtain fresh cut sugar cane as a result of wet weather.

Furthermore the present invention provides for partial processing of sugar cane in outlying areas. Whilst the cost of transport of fresh sugar cane limits the distance from a sugar cane factory that sugar cane may be grown economically, preserved sugar cane has a substantially reduced weight and bulk and may be economically transported greater distances. This reduces the number of sugar cane processing plants required in a region and permits fewer larger facilities to cater for a region. Furthermore, as sugar cane starts to deteriorate as soon as it is cut the process of the present invention allows the fresh cut sugar cane to be preserved in small, and potentially transportable facilities that may be dispersed throughout a region and the preserved sugar cane transported to a full processing plant. The consequences of the inevitable delays in transporting fresh sugar cane over long distances are reduced providing increased recovery and improved quality of the final product. Partial processing according to the present invention makes a product with about one third the mass and bulk of fresh cane. The product is resistant to deterioration and therefore may be stored and transported to an established factory at any convenient time. Processing in the remote location according to the teachings of the present invention may be carried out on a scale that would not be economic for processing to crystal sugar because the process and equipment are much less complicated and expensive compared to a conventional sugar cane factory.

Another advantage of the present invention concerns the common need to rationalise existing sugar cane factories. The need to rationalise may occur due to the increasing cost of operating two or more sugar cane factories in the same area or because a sugar cane factory must be relocated for social or environmental reasons. The process and equipment for sugar cane preservation disclosed herein will reduce the cost of combining regional processing in the one factory and of relocating a sugar cane factory. The combination of amalgamation and extended processing of preserved cane reinforces the economic viability of co-production e.g. ethanol, electricity and paper pulp.

The preservation of sugar cane is most readily achieved by removal of most of the water that normally accounts for more than two thirds of the mass of fresh sugar cane. Of course the removal of such a large fraction of the original mass of the sugar cane achieves other benefits relating to transport and storage already mentioned. Removal of water concentrates the soluble solids. The preserving effect of high concentrations of solutes in the sugar cane enhanced.

The increasing value of renewable energy is a new factor promoting the production of electricity and ethanol as by-products from sugar cane factories. In the tropical environment in which sugar cane is grown, the peak period for electricity consumption and price is usually the summer months, whilst the sugar cane factories operate in the winter months. Therefore the present invention provides increased overall profitability as a result of electricity production in the summer period and also as a result of production during the extended operation of the sugar cane factory.

In order that the invention may be more fully understood and put into practice, preferred embodiments thereof will now be described with reference to the accompanying drawings.

### BRIEF DESCRIPTION OF THE DRAWINGS

FIG. 1 is a schematic representation of one embodiment of the process of the present invention employed in parallel with a conventional sugar cane processing facility;

FIG. 2 is a schematic representation of another embodiment of the process of the present invention employed in a stand-alone sugar cane preserving facility; and

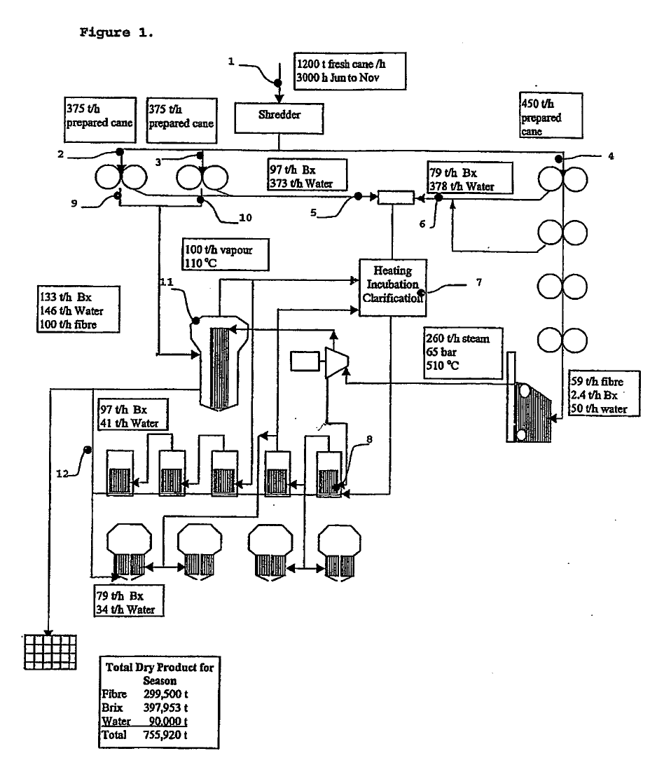

The example in FIG. 1 combines the cane preservation process with conventional juice extraction, processing, evaporation and crystallisation. The example is typical of the use of the invention to rationalise sugar production by part processing of sugar cane previously crushed at a neighbouring sugar factory. The incoming sugar cane is shredded (1) and then splits into three streams (2, 3, 4). The third stream (4) is through two roll crushers to extract the soluble constituents and water from the sugar cane. Water is added conventionally in countercurrent flow to assist the removal of soluble constituents (not illustrated).

The two other streams of shredded sugar cane (2, 3) are crushed separately in one or more stages to extract as much sugar and water bearing juice as possible without the addition of water. There is no special significance in the parallel processing of two separate streams. The example serves to demonstrate that the crushing capacity of an existing sugar cane factory may be conveniently increased in steps relatively inexpensively.

The expressed juice (5) is combined with the mixed juice that is conventionally extracted (6). Following normal juice clarification processes (7), the combined and clarified juice is evaporated to produce a syrup using conventional multiple effect evaporation (8).

The partially extracted bagasse (9, 10) is further processed in a steam drier (11) to remove water. The use of a steam drier in this invention provides a unique combination and embodiment of the known principles of drying by superheated steam and pulse fluidisation.

A portion of the syrup stream (12), generally containing the same proportion of soluble solids as that in the expressed juice stream (5) relative to the combined stream entering the clarification process (7) is mixed with the dried bagasse.

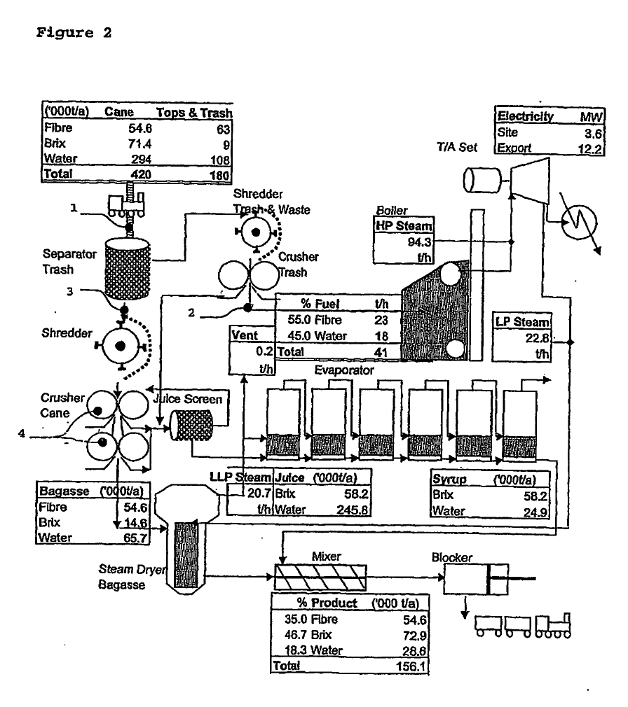

FIG. 2 illustrates the stand-alone production of preserved cane. In this example, Cane tops and trash are separated (1) shredded and dewatered by roll crushers preferably of the two-roll type already mentioned.

The dewatered tops and trash stream (2) is used for fuel in a boiler to produce steam and electricity.

Cleaned cane (3) is preferably crushed in a two-stage roll crusher (4) to maximise the mechanical removal of juice.

Persons skilled in the art will appreciate that the invention described above may be subject to improvements and modifications that will be apparent without departing from the spirit and scope of the invention described herein.

1. A process for the preservation of plant materials comprising the steps of crushing the plant materials to separate a juice portion and a pulp portion, thermally dewatering said pulp portion to form a dewatered pulp, concentrating said juice portion to form a syrup, and combining said dewatered pulp and said syrup to form a preserved plant material.

2. A process according to claim 1 wherein plant material is crushed in a roll or screw press to separate the juice portion from the pulp portion.

3. A process according to claim 2 wherein plant material is crushed in a roll crusher where the plant material is passed between one or more nips of opposed counter-rotating rolls.

4. A process according to claim 3 wherein plant material is crushed in a roll crusher having multiple rolls with multiple nips.

5. A process according to any one of claims 1 to 4 wherein the pulp portion is thermally dewatered by heating the pulp portion with hot gasses in a dryer.

6. A process according to claim 5 wherein dryer is selected from rotating drum dryers and flash type dryers.

7. A process according to claim 5 wherein the pulp portion is conveyed by the drying gasses, multiple-tray, moving bed and fluidized bed dryers.

8. A process according to claim 5 wherein superheated steam is used as a drying medium to thermally dewater the pulp portion.

9. A process according to claim 8 wherein the steam is heated by a heat exchanger using the condensation of steam at a higher pressure.

10. A process according to claim 8 wherein the steam is heated by a heat exchanger using hot gas.

11. A process according to claim 8 wherein the dryer uses superheated steam and operates at elevated pressures.

12. A process according to claim 8 wherein the pulp portion is fed into and extracted from the dryer using a rotating valve, a screw feeder, or a plug feeder.

13. A process according to claim 12 wherein the plug feeder is operated by a piston having a reciprocal stroke.

14. A process according to claim 13 wherein pulp portion is fed radially into a bore of the plug feeder with the piston in a first position and the pulp portion in the bore is driven by the piston through the bore as the piston is driven to a second position before the piston is reciprocated to the first position.

15. A process according to claim 8 wherein a bed of pulp is fluidised whereby contact between the pulp and the superheated steam drying medium is achieved by upward flow of the steam through a bed of the pulp.

16. A process according to claim 15 wherein the dryer for dewatering pulp includes a drying chamber comprising a perforated plate for supporting a bed of pulp.

17. A process according to claim 16 wherein the perforated plate is disposed above a plenum containing superheated steam wherein superheated steam is intermittently passed through the perforated plate whereby the bed of pulp is intermittently fluidised.

18. A process according to claim 8 wherein the steam is forced through a bed of pulp portion from above and collected below a perforated plate.

19. A process according to claim 1 wherein the juice is concentrated to the syrup by removing water from the juice by evaporation.

20. A process according to claim 19 wherein the evaporation is carried out in stages wherein a first evaporation stage is supplied with steam and subsequent evaporation stages are heated by steam produced by the preceding stage.

21. A process according to claim 18 wherein the steam is supplied by extraction from the dryer.

22. A process according to claim 1 wherein the plant material is selected from the group consisting of sugar cane, sweet sorghum and lucerne.

23. A process according to claim 22 wherein the plant material is sugar cane.

24. A process according to claim 23 wherein the sugar cane is cleaned prior to the step of crushing the sugar cane.

25. A process according to claim 23 wherein the moisture content of the pulp portion is less than 55% by weight.

26. A process according to claim 25 wherein the moisture content of the pulp portion is in the range of from 46% to 52% by weight.

27. A process according to claim 25 wherein the moisture content of the pulp portion of crushed sugar cane is about 48% by weight.

28. A process according to claim 23 wherein the moisture content of the dewatered pulp is in the range of from 10% to 35% by weight.

29. A process according to claim 23 wherein the moisture content of the dewatered pulp is in the range of from 12% to 15%.

30. A process according to claim 23 wherein the juice portion derived from the crushing of the sugar cane contains 15% to 23% of soluble components.

31. A process according to claim 30 wherein the soluble components include sucrose, glucose, fructose, other organic matter and soluble salts.

32. A process according to claim 23 wherein the solids content of syrup derived from the juice of sugar cane is in the range of from 70% to 75% by weight.

33. A process according to claim 23 wherein the syrup is at a temperature in the range of from 65° C. to 70° C. and the dewatered pulp is at a temperature of at least 90° C. in the step where the syrup and the dewatered pulp are combined to form preserved sugar cane.

34. A process according to claim 23 wherein the preserved sugar cane may be formed into blocks of mixed syrup and dried bagasse under pressure whereby the potential for rehydration is reduced.

35. A process according to claim 34 wherein the blocks are wrapped in plastic film.

36. A process for refining sugar comprising the steps of preserving sugar cane according to the process of claim 1, and subsequently refining the preserved sugar in a sugar refining facility.

37. A process according to claim 36 further including the step of transporting the preserved sugar cane to the sugar refining facility.
